(19) United States
(12) Patent Application Publication
(10) Pub. No.: US 2026/0347154 A1
(43) Pub. Date: Nov. 5, 2026

(54) METHOD FOR DECOUPLING A CRANE BLOCK FROM AN OFFSHORE CRANE

(71) Applicant: GustoMSC B.V., Schiedam (NL)

(72) Inventor: Steven Franciscus SLOOT, Spijkenisse (NL)

(21) Appl. No.: 19/116,435

(22) PCT Filed: Sep. 29, 2023
(86) PCT No.: PCT/NL2023/050511

§ 371 Date: Mar. 28, 2025

(30) Foreign Application Priority Data
Sep. 30, 2022 (NL) 2033206

(51) Int. Cl. B66C 23/62; B66C 23/52

(52) U.S. Cl. CPC B66C 23/62; B66C 23/52

(57) ABSTRACT

Method for decoupling a part of a crane block comprising at least one sheave block comprising at least one sheave from a crane boom of a crane mounted onto a vessel, the method comprising: positioning the crane boom in an inclined position; lowering the part of the crane block towards the vessel; connecting an auxiliary line to at least one of the at least one sheave block to be decoupled from the part of the crane block; decoupling the to the auxiliary line connected sheave blocks from the part of the crane block; pulling the to the auxiliary line connected sheave blocks towards the crane boom.

### BACKGROUND

The invention relates to a method for decoupling a crane block from an offshore crane, for example for decoupling a part of a crane block from an offshore crane.

Offshore vessels, for example offshore crane vessels, are typically equipped with a crane for performing lifting and handling operations offshore. An offshore crane vessel can be any type of vessel that is typically used in offshore operations, in particular in offshore wind operations, e.g. it can be a jack-up, a dynamic positioning vessel, a barge, a ship etc. In particular vessels that are intended for the installation of wind turbine towers, wind turbine blades, monopiles etc. are usually equipped with large cranes that can lift a heavy weight, as well as that can reach relatively high, in particular when lifting a nacelle or a wind turbine blade for the installation thereof on a wind turbine tower. Such cranes tend to become larger and larger due to the increasing height of wind turbine towers and the increasing length of wind turbine blades. The crane can become so large that the length of the crane boom extends the length of the vessel. When the crane boom is in rest position, meaning that the crane boom is in a lying position or in an approximately horizontal position, in which it is stored during sailing or transit from the harbor to an offshore site or from one offshore site to another, the crane boom extends outwardly of the vessel.

The offshore crane is equipped with at least one crane block for lifting and/or hoisting a load. The crane block is provided at the end of the crane boom and can be lowered via a reeving system comprising hoist lines that pass via sheaves, the crane boom, etc. towards a winch installed at or near a crane base. The crane block itself typically comprises multiple sheave blocks comprising sheaves around which hoisting lines pass. The crane block may comprise a lower block and one or more sheave blocks. The lower block and the sheave blocks can be decouplable connected to each other. A sheave block may comprise one or more sheaves. The lower block typically may be arranged for connection with a handling element such as a crane hook. The crane may be provided with multiple crane blocks, each comprising a lower block and at least one upper sheave block.

Such a crane block typically is very heavy and can have for example a weight of about 100 mtonnes, for lifting up to 2500 mtonnes safe working load. These numbers are exemplary, but it is understood that the crane blocks envisaged may weigh several thousands mtonnes. When the crane boom, and thus the crane block at the end of the crane boom, is in rest position, part of the crane boom extends outwardly of the vessel and the heavy weight of the crane block is hanging at the outer end of the boom outboard of the vessel. During sailing, such heavy weight may induce large loads, in particular fatigue loads, into the crane boom, thus impairing the strength and life time of the crane boom. There is thus a need for reducing the loads on the crane boom, in particular, during sailing in rest position.

Solutions that have been considered are to provide an extendable boom, having at least one boom section that can be extended for operations and that can be slid in for storing in the rest position. In the slid in position, the crane boom can then be stored within contours of the vessel, such that the crane block can be stored onto a deck of the vessel. The crane block then does not induce loads into the crane boom during sailing. However, such extendable booms are more complex, and, more expensive. There remains a need for a more cost effective solution to relieve the crane boom as much as possible from loads from the crane block when in rest position.

An aim of the invention may be to provide an improved condition of the crane boom when the crane boom is in crane boom rest position. Alternatively and/or additionally, an aim of the invention may be to provide an improved method for reducing the loads on the crane boom, in particular, during sailing in rest position on the crane boom rest.

To that end, the invention provides for a method according to claim 1.

With this method, the crane boom in rest position extends partially outside of the vessel, while the decoupled part of the crane block rests on a structure of the vessel. A part of the crane block, in particular the lower block or a part of the lower block, is decoupled from the crane boom, thereby reducing the weight hanging from the crane boom when the crane boom is in rest position, e.g. during transit. When decoupling the lower block from the crane boom by decoupling at least one of the sheave blocks from the crane block, the weight at the crane boom is significantly reduced as compared to the entire crane block, thereby reducing load and/or fatigue on the crane boom. As such, for a crane boom that is longer than the vessel, such that in rest position, it extends outwardly of the vessel, the decoupling of the lower block can be done in a safe and reliable manner.

### SUMMARY

The invention provides a method for decoupling a part of a crane block, comprising at least one sheave block comprising at least one sheave, from a crane boom of a crane mounted onto a vessel. The method comprises positioning the crane boom in an inclined position; lowering the part of the crane block towards the vessel; connecting an auxiliary line to at least one of the at least one sheave block to be decoupled from the part of the crane block; decoupling the to the auxiliary line connected sheave blocks from the part of the crane block; pulling the to the auxiliary line connected sheave blocks towards the crane boom.

Sheaves may be comprised by a sheave block. A sheave block may comprise one or more sheaves. It is envisaged that the operations according to the method may be applied to the sheave block(s) or directly to the sheave(s). The method for decoupling a part of a crane block is understood to be a method for decoupling a part of one or more crane blocks. Multiple crane blocks may be provided to the crane, all or some of them may be partially decoupled.

A crane block is understood to comprise a lower block to which one or more sheave blocks can be connected. A sheave block can comprise one or more sheaves. The crane block can be a splittable block in which part of the lower block with associated sheave blocks can be deconnected from another part of the lower block with associated sheaves. The method is applicable for any type of crane block with at least one removable connectable sheave block, such that the lower block can be entirely or partially be decoupled from the hoisting system.

By positioning the crane boom in an inclined position, the crane block can be substantially vertically lowered onto the vessel. By providing the inclined position, the crane block becomes located inside of the contour or boundaries of the vessel as it is lowered towards the vessel. By the contour or boundaries of the vessel is meant the extent or border of the vessel including any outwardly extending parts, for example a boom rest, connected to the vessel, as would be seen from a top view of the vessel.

The inclined position may be determined based on a position of the crane block with respect to a desired position of the crane block, a ratio between a length of the crane boom and a length or a width of the vessel, a ratio of a weight of the crane boom and a weight of the vessel, a weight distribution of the crane boom in relation to a weight distribution of the vessel, weather conditions, or based on a combination of these parameters, or based on a combination of any one of these and/or other parameters.

The inclined position may be described by an elevation angle of the crane boom with respect to the vessel, for example with respect to the deck of the vessel, and by an azimuth angle of the crane boom with respect to the vessel. The elevation angle may be referred to as an angle of inclination in this description.

The inclined position may comprise an angle of inclination of about 45 degrees between the crane boom and a plane substantially parallel to a deck of the vessel or to a water surface of the water in which the vessel is sailing, for example a substantially horizontal plane.

The angle of inclination may be larger or smaller than 45 degrees. The angle of inclination may depend on the dimensions, weight and/or weight distribution of the crane boom and the vessel, location of the crane boom with respect to the vessel, free space on the deck of the vessel for placing the part of the crane block, location of a cradle for receiving and/or holding the part of the crane block, et cetera. Advantageously, the angle of inclination is such that, in the inclined position, the crane block can be lowered onto the vessel, this can be a dedicated area on the deck of the vessel, or can be a dedicated structure extending from the vessel, such as a boom rest extension.

It is also envisaged that the crane block may be lowered along a direction not substantially vertical.

An auxiliary component may be used for guiding the crane block onto the vessel along a predetermined path in a controlled manner. The auxiliary component may be such that it aids in guiding the crane block towards the vessel along a substantially vertical direction, or along a direction not substantially vertical. Such an auxiliary component may for example be a tugging device. The auxiliary component may comprise an auxiliary line. After positioning the crane boom in the inclined position, the crane block can be lowered towards the vessel in order to be able to remove the part of the crane block from the crane boom for reducing forces acting on the crane boom.

The auxiliary line can be provided by the tugging device. Such a tugging device can comprise a tugging element which can be a winch available on the crane, or on a crane house thereof, or can be a winch available on the deck of the vessel or a winch arranged on other structures of the vessel, for example on a boom rest or a cradle or on a foldable deck or on the sheave block etc. The tugging device may comprise an auxiliary line, for example a tugger line or a tugger rope. The auxiliary component may be the tugging device, which tugging device comprises a tugging element, such as a winch, and an auxiliary line, such as the tugger line. The auxiliary line can be connected on one end to at least one of the sheaves or sheave blocks to be decoupled from the part of the crane block and at the other end can be connected to the tugging element, e.g. a winch, of the tugging device.

An opposing end of the auxiliary line may be fixed onto the tugging element, which may comprise a post or a winch, for example a winch of the crane boom or a separate tug winch arranged on the vessel.

By providing the auxiliary line, it becomes possible to apply an auxiliary force, for example a tugging force, to the at least one of the sheaves or sheave blocks to be decoupled. The tugging force may be applied in order to effectively weigh the at least one of the sheaves or sheave blocks to be decoupled. A weight force of the at least one of the sheaves or sheave blocks to be decoupled itself may not suffice as a counter force to a pulling force applied to pull the sheaves or sheave blocks towards the crane boom. Otherwise said, the at least one of the sheaves or sheave blocks to be decoupled may not be heavy enough to allow an efficient pulling of sheaves or sheave blocks towards the crane boom after being decoupled. The applied tugging force counteracts the pulling force together with the weight force of the at least one of the sheaves or sheave blocks to be decoupled and thus forms an additional counter force for the pulling force.

It is also envisaged that such an additional force to the at least one of the sheaves or sheave blocks to be decoupled may be applied by other means than through use of an auxiliary line.

After connecting the auxiliary line, the to the auxiliary line connected or tugged sheaves or sheave blocks are decoupled or removed from the part of the crane block. Decoupling the to the auxiliary line connected sheave blocks from the part of the at least one crane block may be performed manually or with use of automation devices. The decoupled part of the crane block, typically the lower block, then remains on the vessel, while the decoupled sheave blocks can be pulled upwardly.

Finally, the tugged sheaves or sheave blocks are pulled towards the crane boom. Thus, after being decoupled, the decoupled sheave or sheave blocks can be pulled towards the crane boom in a controlled manner with the auxiliary line. When the sheave or sheave block is at the crane boom, the auxiliary line remains connected, but can be pulled more tight to reduce any slack in the line. By connecting the auxiliary line to the at least one decoupled sheave block or sheave, the decoupled sheave block can be guided during upward movement. Preferably, the auxiliary line may be in a constant tension mode, in order to provide for an even more controlled pulling of the decoupled sheave blocks upwardly.

The crane boom may comprise a support structure, for example a support beam or a support surface, arranged in, at or near a crane boom end or a crane boom tip. The support structure is such that sheave lines may pass through or along it and such that a sheave or sheave block that is being pulled up is stopped by the support structure. The support beam is arranged for abutment with the decoupled sheave blocks when pulled up. As such, the support structure inhibits further upwards movement of the sheaves or sheave blocks in order to prevent the sheaves or sheave block from tangling with other sheave blocks present near the crane boom tip or on the crane boom or otherwise damaging components of the crane. The sheaves of the crane block may lean and/or be pulled against a lower surface of the support structure. The support beam may be provided with seats to receive the decoupled sheave blocks, and, as such, to effectively store the decoupled sheave blocks or sheaves. A part of the sheaves or sheave blocks may even be received into a receiving opening of the support structure.

When the decoupled sheave blocks are pulled upwardly, preferably against the support beam, the part of the crane block is advantageously decoupled from the crane boom, and from the hoisting system. Then, the heavy weight of the part of the crane block is at the vessel and supported by the vessel, while at the crane boom, the sheaves or sheave blocks remain, counting for much less weight than the entire crane block, thereby reducing the loads and/or motions on the crane boom. This is advantageous for sailing, there may be less concerns for the heavy crane block otherwise hanging outboard of the vessel at the crane boom end. This may be advantageous for the crane boom, in particular for the life time of the crane boom, while fatigue loads may be reduced.

The method may further comprise, lowering the crane boom towards the vessel into a rest position.

The rest position may comprise a substantially horizontal position, allowing a more efficient sailing of the vessel. In the rest position, the crane boom may extend outside of the vessel. The crane boom may be positioned onto a boom rest in the rest position, the boom rest provided to keep the crane boom fixated in the rest position. With the crane boom in rest position, the crane boom can be safely positioned for sailing. The crane boom typically is longer than the vessel, also longer than the vessel with a boom rest extension extending outwardly of the vessel as well. Even then, part of the crane boom is free hanging outboard of the vessel.

Advantageously, the crane block may be lowered into a cradle mounted on the vessel. Advantageously a cradle can be provided in which the crane block can be securely received when lowering the crane block ed onto the vessel. After decoupling of at least one sheave block from the crane block, the decoupled lower block can remain in the cradle, such that it can be stored safely and securely for and during sailing of the vessel.

The cradle may comprise a frame construction whereto the lower block can be safely secured. The frame construction may comprise a receiving space for receiving the crane block. The cradle may be provided with additional fastening means to prevent or reduce a moment of the crane block, in particular of the lower block, with respect to the cradle. By providing a cradle in which the part of the crane block can be safely received, the cradle and the part of the crane block can be securely fastened to the vessel for sailing. Receiving the part of the crane block in the cradle also allows approaching of the crane block, for example for decoupling of the sheaves or sheave blocks, in a safe manner.

The cradle may be mounted on a deck of the vessel, or may be mounted on another structure of the vessel, for example a boom rest or elsewhere. A location of the cradle may be chosen based on the length of the crane boom.

During pulling the to the auxiliary line connected sheave blocks or sheaves towards the crane boom, the auxiliary line may advantageously be tensioned, for example in a constant tension mode.

By tensioning the auxiliary line, the auxiliary force can be applied to the at least one of the sheaves or sheave blocks to be decoupled as explained above in a controlled manner. The tensioned auxiliary line provides a force to the at least one of the sheaves or sheave blocks to be decoupled in order to increase an effective weight of the sheaves or sheave blocks.

Tensioning may be performed in a controlled manner through use of a winch, for example a winch of the crane boom or a separate auxiliary winch arranged on the vessel.

During lowering the crane boom into the rest position, the auxiliary line may advantageously be tensioned, for example in a constant tension mode. This can be done in order to refrain the auxiliary line from hanging loosely around the crane boom. Letting the auxiliary line to slack during tilting of the boom into the rest position would reduce safety and controllability of the auxiliary line movements.

When two or more sheave blocks are decoupled from the lower block, and are being pulled upwardly simultaneously, it can be advantageous to connect the associated hoisting lines of the respective sheave blocks with a connecting element. Such connecting element may obviate or prevent twisting or tangling from the hoisting lines while pulling up. Also, such connecting element may facilitate landing of the sheave blocks to the support beam in upper position.

The method of lowering the crane block onto the vessel while the crane boom is in inclined position, can also be used for changing a handling tool, such as a crane hook, connected to the crane block. Then the crane block can safely be lowered onto the vessel, e.g. in a cradle, or on deck, or on a boom rest extension, etc. There, the handling tool can be safely removed from the crane block and can be exchanged with a different handling tool. Such exchange of handling tool can then be done without lowering the entire crane boom into its rest position.

To bring the crane in operational condition again, the method can be executed in reverse direction. The crane boom can be brought in an inclined position in which the decoupled sheave blocks can be lowered towards the part of the crane block that is on the vessel. Preferably, the auxiliary line, still connected to the decoupled sheave blocks, can be used for guidance during lowering, and/or for tensioning during lowering of the sheave blocks. When the sheave blocks are lowered and received in their respective receiving openings of the decoupled part of the crane block, they can be connected again to the part of the crane block, to form the crane block. After connection of the sheave blocks to the part of the crane block, the auxiliary line can be disconnected and stored at the tugging element for example. The crane block is then connected again to the crane, and the crane can be in operational condition.

The invention further provides a vessel comprising a crane, the crane comprising a crane boom with at least one crane block, the at least one crane block comprising at least one sheave block comprising at least one sheave of which at least one sheave or sheave block is decouplable from the a part of the at least one crane block, wherein the crane boom is longer than a length of the vessel, the vessel being provided with a boom rest to receive the crane boom in a rest position, e.g. for sailing, wherein the vessel further is provided with a cradle for receiving the part of the at least one crane block and decoupling the part of the at least one crane block from the at least one decouplable sheave or sheave block when the part of the at least one crane block is in the cradle and the crane boom is in an inclined position.

The crane block or multiple crane blocks may comprise one or more splittable or non-splittable crane blocks which may each comprise a multi-sheave or single-sheave crane block. Splittable crane blocks may comprise two or more from each other separable parts, each comprising a separate set of sheaves, while non-splittable crane blocks comprise a single part from which sheaves may be removed.

In case the crane block comprises a non-splittable crane block, decoupling the sheaves or sheave blocks from the part of the crane block may comprise removing all the sheaves or sheave blocks at once, such that the entire, single part of the crane block remains in the cradle.

In case of a splittable crane block, a first set of sheaves may be removed from a first part of the crane block, while a second set of sheaves remains coupled to a second part of the crane block. If the decoupled sheaves or sheave blocks are being pulled up by the crane boom, the first part of the crane block may remain in the cradle, while the second part of the crane block may be pulled up together with the sheaves or sheave blocks.

The boom rest may be provided to keep the crane boom fixated in the rest position and may comprise a frame structure. The boom rest provides a resting functionality such that the boom stays in place merely because of the weight of the boom rest. Any additional fastening components can be optional.

The vessel may be provided with a boom rest extension, extending outside of the vessel, the boom rest extension being provided with the boom rest for receiving the crane boom in rest position.

The boom rest extension may be an arm e.g. a truss structured arm, extending itself also outwardly of the vessel. By providing the boom rest extension outboard of the vessel, the support position of the boom is brought as far as possible towards the crane boom end, also called crane boom tip. By bringing the support position so far outboard, the boom can be supported as good as possible, while reducing the moments and loads induced by the non-supported outer end of the crane boom.

Advantageously, the cradle may be provided on the boom rest extension, preferably adjacent the boom rest. As such, the part of the crane block can be decoupled closely to the boom rest, such that the length of the auxiliary line hanging free over water can be reduced. Also, with the boom rest and the cradle as far as possible outboard, it can beneficial for loads on the crane boom. For operational efficiency it can be advantageous to have the cradle positioned closely to the boom rest. As such, operations to bring the crane to the rest position can be done in proximity of each other. Of course, the cradle may also be positioned e.g. on the deck, while the boom rest may be on a boom rest extension extending outwardly of the vessel. It can be advantageous to bring the boom rest as far as possible outboard, in view of such a long crane boom. Even when the boom rest position is as far as possible outboard, there is still a free hanging part of the crane boom extending further than the boom rest. Such free hanging part is not supported and is preferably limited in length to reduce loads and/or overturning moment.

Further advantageous embodiments are provided by the features of the subclaims.

### BRIEF DESCRIPTION OF THE FIGURES

The invention will further be elucidated with reference to the drawing comprising figures of exemplary embodiments. In the drawing there are the following figures.

FIG. 1 shows a schematic side view of a crane comprising a crane block, wherein a crane boom is arranged in an inclined position.

FIGS. 2a and 2b show schematic side views of a crane block comprising at least one sheave block.

FIG. 3 shows a schematic side view of a crane comprising a crane block, wherein an auxiliary line is connected to at least one of the sheaves or sheave blocks to be decoupled.

FIGS. 4a and 4b show schematic side views of a crane block after connection of an auxiliary line to at least one of the sheaves or sheave blocks to be decoupled.

FIG. 5 shows a schematic side view of a crane comprising a crane block, wherein the at least one of the sheaves or sheave blocks to be decoupled are pulled out of the crane block.

FIGS. 6a and 6b show schematic side views of a crane block after pulling of the at least one of the sheaves or sheave blocks to be decoupled out of the crane block.

FIG. 7 shows a schematic side view of a crane comprising a crane block, wherein the at least one of the sheaves or sheave blocks to be decoupled is being pulled up.

FIGS. 8a and 8b show schematic side views of a crane block during pulling up of the at least one of the sheaves or sheave blocks to be decoupled.

FIG. 9 shows a schematic side view of a crane comprising a crane block, wherein the at least one of the sheaves or sheave blocks to be decoupled have been pulled up towards the crane boom.

FIGS. 10a and 10b show schematic side views of the at least one of the sheaves or sheave blocks to be decoupled after being pulled up towards the crane boom.

FIG. 11 shows a schematic side view of a crane comprising a crane block, wherein a main hoist line is tightened after the at least one of the sheaves or sheave blocks to be decoupled have been pulled up towards the crane boom.

FIGS. 12a and 12b show schematic side views of the at least one of the sheaves or sheave blocks to be decoupled after tightening of the main hoist line.

FIG. 13 shows a schematic side view of a crane comprising a crane block, wherein the crane boom is being lowered into a rest position.

FIG. 14 shows a schematic side view of a crane comprising a crane block, wherein the crane boom is in a rest position.

FIG. 15 shows a more detailed side view of a boom rest extension.

FIGS. 16a and 16b show the crane block in a coupled and in a decoupled state respectively.

FIG. 17 shows a side view of part of a crane comprising a boom rest extension.

FIG. 18 shows a vessel comprising a crane.

FIGS. 19A and 19B show side views of a top of the crane boom in the case that not all the sheaves or sheave blocks have been pulled up.

### DETAILED DESCRIPTION

It is to be noted that the figures are given by way of exemplary examples and are not limiting to the disclosure. The drawings may not be to scale. Corresponding elements are designated with corresponding reference signs.

In order to achieve a reasonable crane boom fatigue life related to ocean transit conditions, it may be required to store part of the crane block, for example a main hoist lower block, in a cradle. That means that lines, which may for example comprise steel wire ropes, may have to be reeved out in order to store the part of the crane block in the cradle and lower the crane boom to the boom rest. After ocean transit, the crane block may have to be reeved in again.

The disclosure comprises a technical proposal for a more simplified and user friendly procedure for splitting off a bigger part of the crane block, without the sheave blocks, without having to perform (un-)reeving actions.

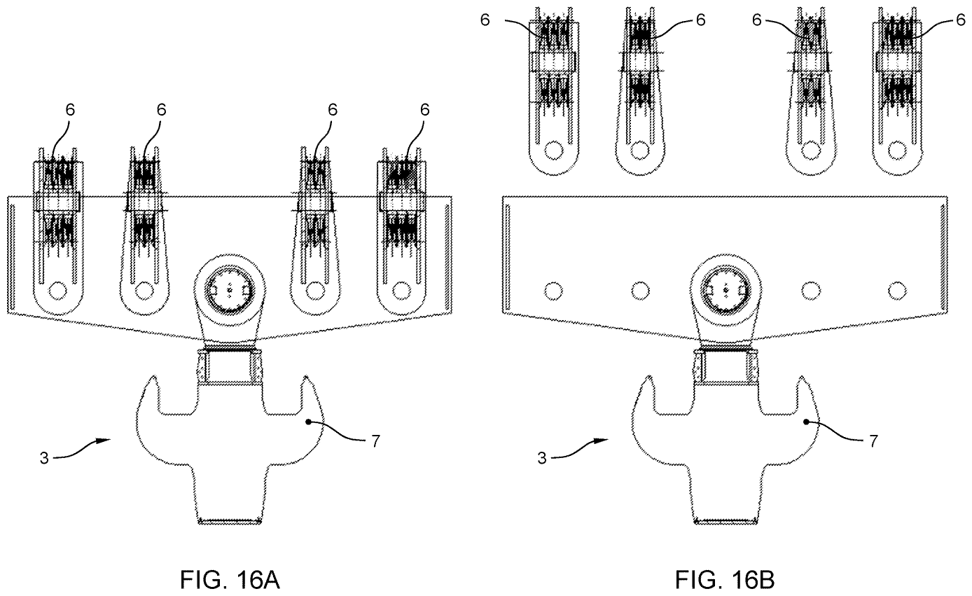

In the exemplary figures, the sheave blocks are connected to the rest of the crane block using pins which may easily be removed, in order to disconnect the sheave blocks from the rest of the lower block (see FIGS. 16A and 16B). The sheave blocks may then be pulled up and stored against a support beam structure at an end of the boom. The weight reduction in the boom by splitting off the lower block part, may for example amount to approximately 75 t. The total weight of the lower block may for example be 100 t. Advantageously, reeving out the blocks may no longer necessary.

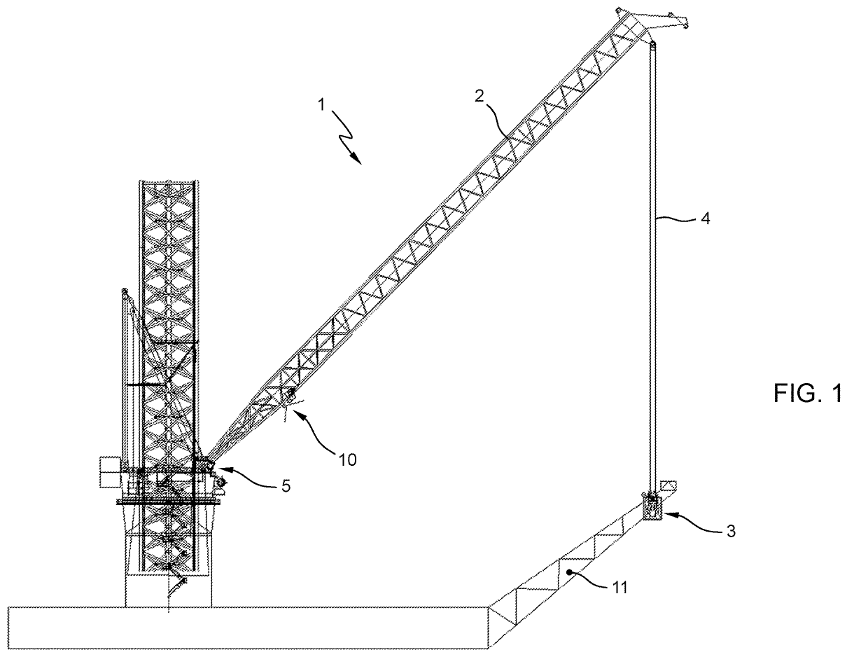

FIG. 1 shows the principal elements of a crane 1, comprising a crane boom 2, a crane block 3 and a main hoist line 4. The crane 1 may further comprise additional components as known in the art, for example a main hoist winch (not shown) which may comprise one or more winches. The invention provides a method for decoupling a part of the at least one crane block, for example crane block 3, comprising at least one sheave block 6 comprising at least one sheave from a crane boom 2 of a crane 1 mounted onto a vessel (not shown in the figures).

In order to achieve a reasonable boom fatigue life related to ocean transit conditions, it may be required to store the crane block 3 in the cradle. The steel wire ropes may be reeved out in order to store the block in the cradle and lower the boom towards the boom rest. This may be a complicated and time consuming operation, especially in offshore conditions. After ocean transit, the block needs to be reeved in again.

The disclosure provides a more simplified and user friendly procedure for splitting off the bigger part of the crane block 3, without the sheave blocks 6, without having to perform (un-)reeving actions.

The crane boom 2 may be mounted to the crane 1 through a rotatable connection 5, which connects the crane boom 2 with a static part of the crane 1 which may be fixated to the vessel.

The crane 1 may be mounted onto the vessel, for example a vessel having a length and/or a width which is smaller than a length of the crane boom 2.

The crane block 3 may comprise any type of crane block, for example a lower block with decouplable sheave blocks, or a splittable block. Main hoist line 4 may comprise a single hoist line, a dual hoist line or any other type of hoist line. In the figures, a dual hoist line is shown as an illustration.

The method comprises positioning the crane boom 2 in an inclined position and lowering the part of the crane block towards the vessel.

In FIG. 1, the crane boom 2 is shown in an exemplary inclined position. By positioning the crane boom 2 in an inclined position, the crane block 3 can be substantially vertically lowered onto the vessel instead of onto a location outside of the vessel, for example into the water of the sea.

The inclined position may be described by an elevation angle of the crane boom with respect to the vessel and by an azimuth angle of the crane boom with respect to the vessel. The elevation angle may be referred to as an angle of inclination in this description. The elevation angle or angle of inclination is indicated as a in the figures.

The inclined position may comprise an angle of inclination a of about 45 degrees between the crane boom 2 and a substantially horizontal plane, approximately perpendicular to the main hoist line 4, as indicated in the figures. The angle of inclination a may be larger or smaller than 45 degrees.

An effective boom length of A×B may be achieved, wherein A comprises a length of the crane boom 2 and B comprises the cosine of the angle of inclination a. As the angle of inclination a ranges from 0 degrees towards 90 degrees, a shorter boom length may be achieved. As such, the angle of inclination a can be tuned depending on the circumstances.

It is also envisaged that the crane 1 comprises multiple crane blocks 3, which may be arranged at a distance along the crane boom 2. In that case, the method may be applied to the multiple crane blocks 3 sequentially, or in parallel.

FIG. 1 also illustrates the crane block being lowered in the cradle just behind a boom rest support structure, in order to be splitted-off from the sheaves or sheave blocks 6.

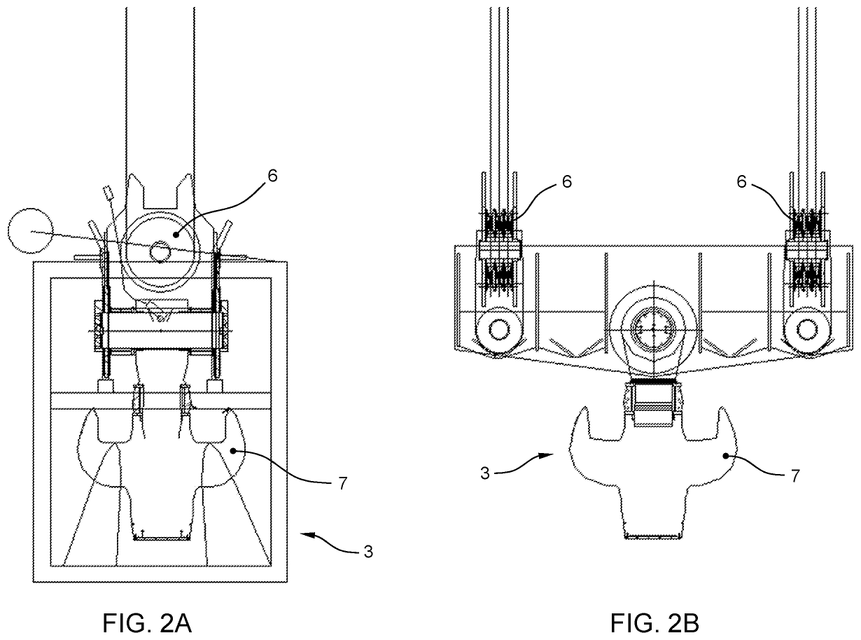

FIGS. 2a and 2b show schematic side views of the crane block 3 comprising at least one sheave block 6. The crane block 3 further comprises a hook 7, which may comprise any type of hook, for example a single or a double hook, a closed or semi-closed hook or otherwise. In the figures, a quadruple hook is shown as an illustration.

The method further comprises connecting an auxiliary line 8 to at least one of the at least one sheave block 6 to be decoupled from the part of the crane block. The auxiliary line 8 may originate from auxiliary winches of the crane 1 or may originate from another winch present on the vessel. The auxiliary line may for example be a rope.

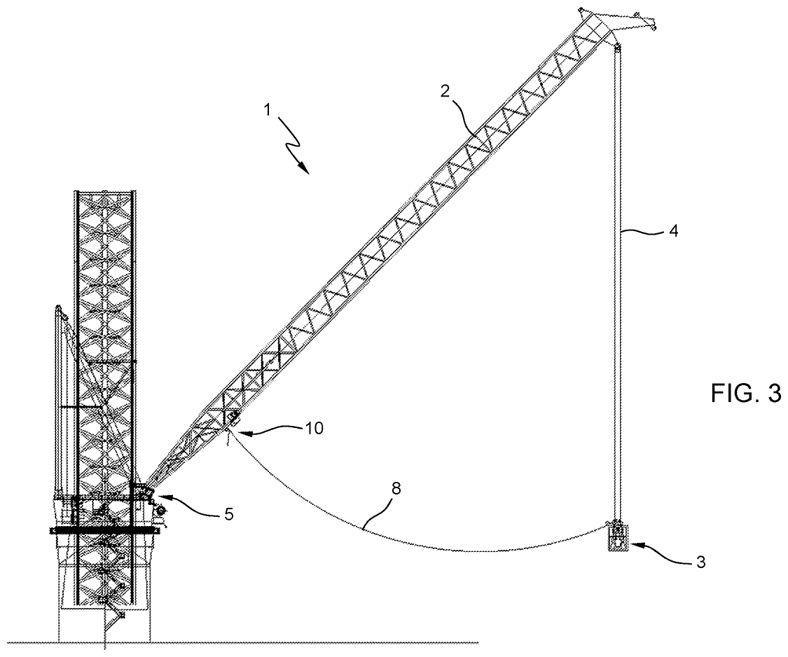

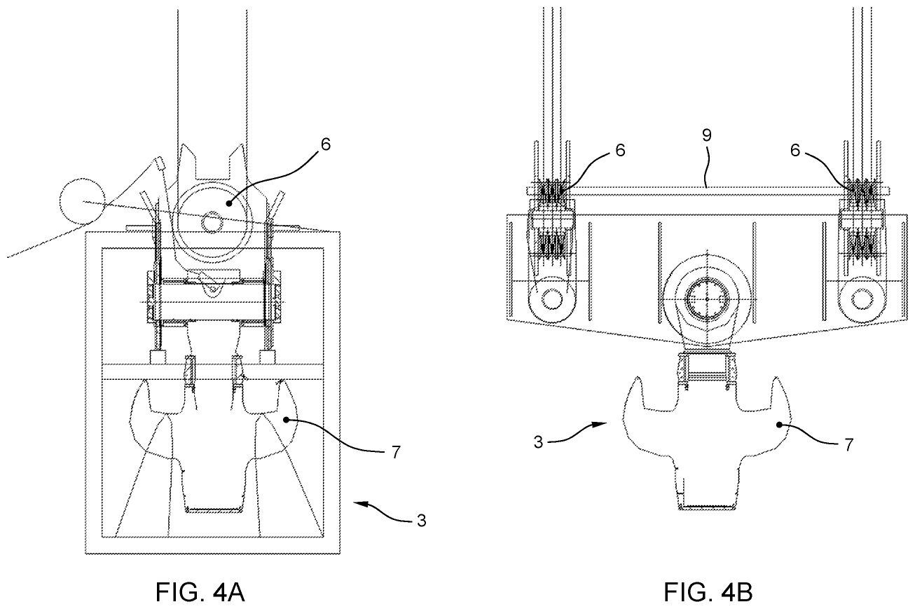

FIG. 3 shows a schematic side view of the crane 1 comprising the crane block 3, wherein the auxiliary line 8 is connected to at least one of the sheave blocks 6 or sheaves to be decoupled. FIGS. 4a and 4b show schematic side views of the crane block 3 after connection of the auxiliary line 8 to the sheaves or sheave blocks 6 to be decoupled.

The auxiliary line 8 may comprise multiple lines, depending on the set-up of the main hoist line 4 of the crane 1 and of the sheave blocks 6.

In practice, the auxiliary line 8 may comprise lengths up to 200 meters and more. Advantageously, the length of the auxiliary line 8 may be over-dimensioned, providing a longer length than strictly necessary for reaching the sheaves.

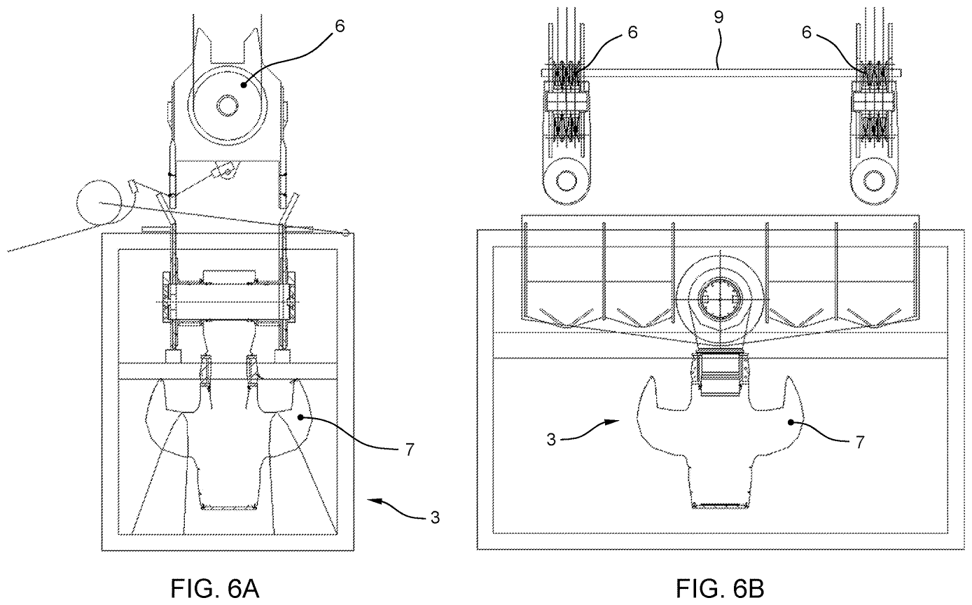

Referring to FIG. 3 and FIGS. 6a and 6b, an auxiliary line 8, for example tugger ropes, from the crane boom 2 may be guided towards connection points on the sheave or sheave block 6. A sheave block may be connected with a single auxiliary line or with multiple auxiliary lines. The sheave blocks 6 can then be disconnected from the lower block 3. The provisions required to connect the sheave blocks 6 to the rest of the lower block 3 may be part of the crane block structure itself such that no additional provisions may be necessary for disconnecting the sheave blocks 6 from the lower block 3.

Advantageously, a connecting element, for example a rod 9, may be provided between the sheaves 6 located at either end of the crane block 3, see FIGS. 4a and 4b. This may aid in preventing twisting of the sheaves or sheave blocks 6.

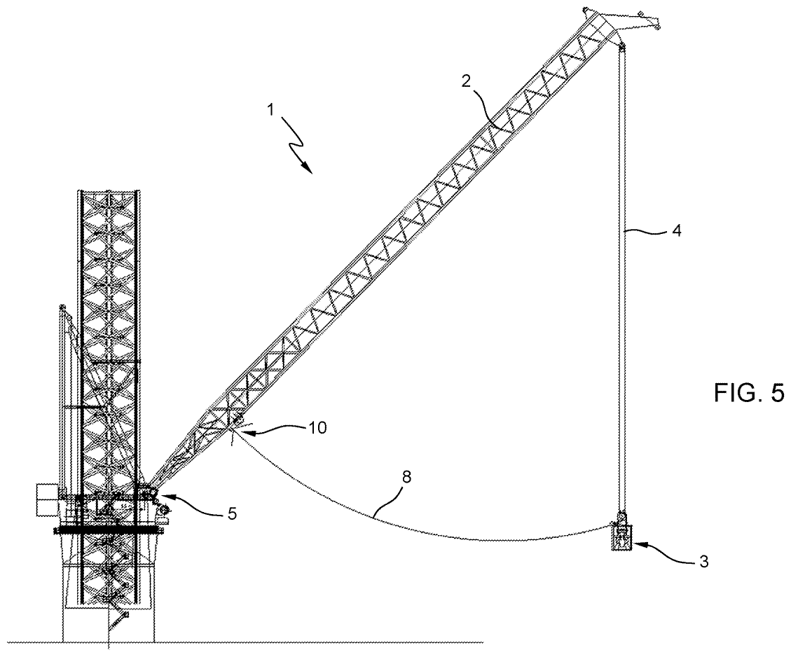

The method further comprises decoupling the to the auxiliary line connected sheaves from the part of the crane block. FIG. 5 shows a schematic side view of the crane 1 comprising the crane block 3, wherein the at least one of the sheaves or sheave blocks 6 to be decoupled are pulled out of the crane block 3. FIGS. 6a and 6b show schematic side views of the crane block 3 after pulling of the at least one of the sheaves or sheave blocks 6 to be decoupled out of the part of the crane block 3.

The sheaves or sheave blocks 6 may be pulled out of the crane block 3 a auxiliary line is under tension, by retracting the connections of the sheaves or sheave blocks 6.

The method further comprises pulling the sheave blocks 6, that are connected to the auxiliary line, towards the crane boom 2.

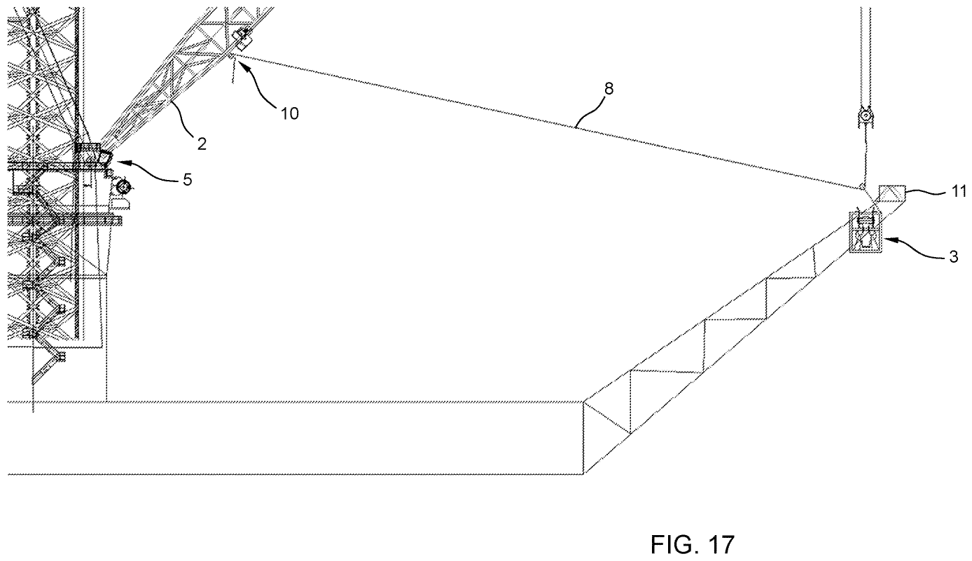

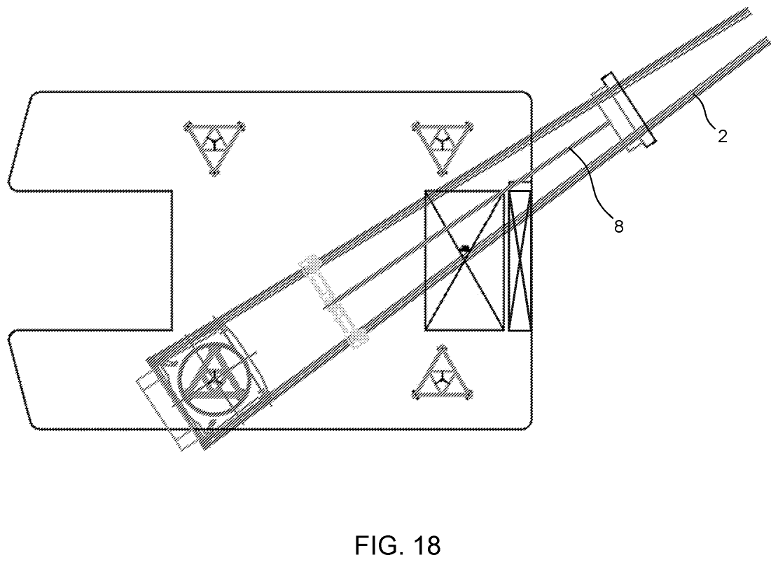

The procedure makes use of the auxiliary line 8, possibly originating from an auxiliary winch attached to the crane 1, to be routed from the crane boom 2 all the way to an expected cradle position in the boom rest structure, see FIGS. 17 and 18. There might be objects on deck (e.g. accommodation, deck cranes navigation lights, etc.) which obstruct the indicated path of the auxiliary line, depending on a maximum elevation of these objects above main deck. A solution with an auxiliary winch near the block basket is possible when it is not possible to reach the block basket with the crane auxiliary lines.

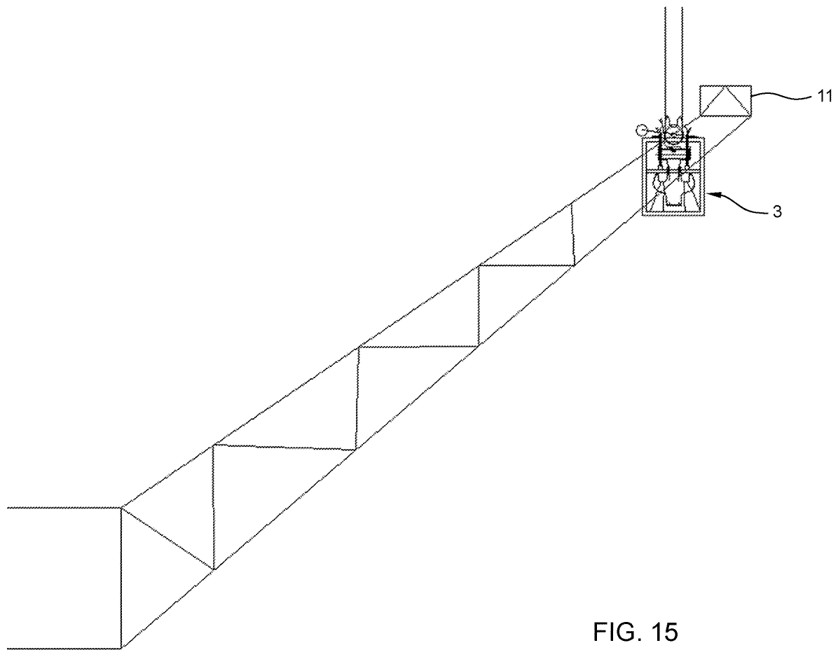

The disclosure may comprise a permanent cradle with access to be implemented in the boom rest support structure, see FIG. 15.

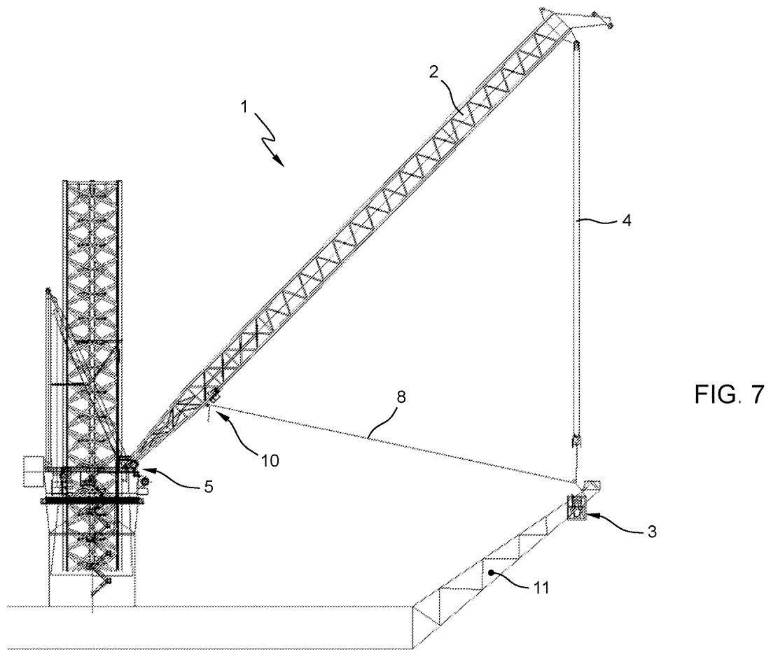

FIG. 7 shows a schematic side view of the crane 1 comprising the crane block 3, wherein the at least one of the sheaves or sheave blocks 6 to be decoupled is being pulled up. The pulling up is for example performed by the main hoist winches, or by another winch on the crane house/crane base of the vessel, and effectuated by counter force provided by the auxiliary line 8, which may advantageously be set to a constant tension until the sheaves or sheave blocks 6 reach the crane boom 2.

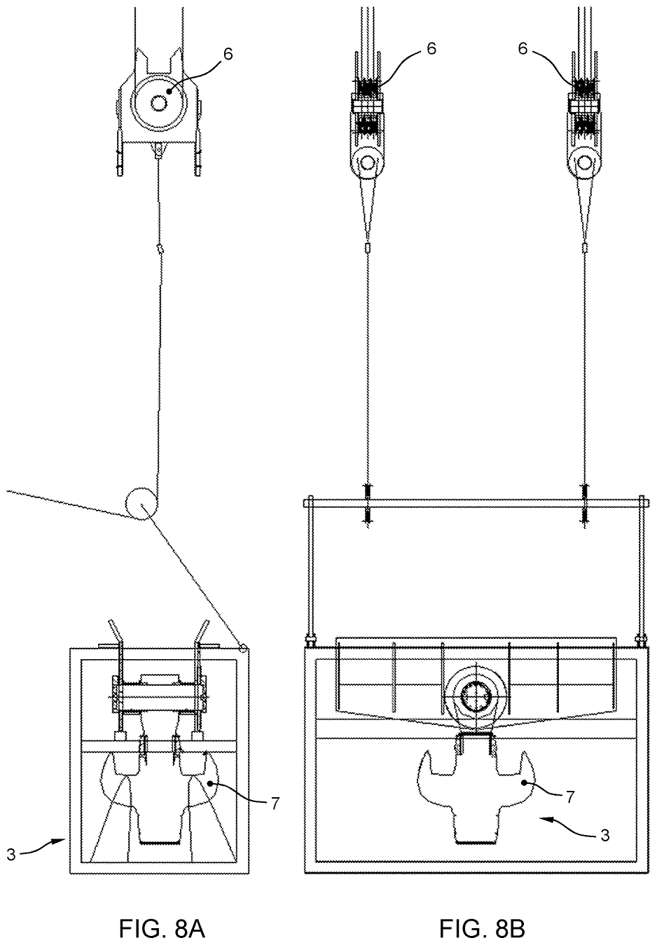

FIGS. 8a and 8b show schematic side views of a part of the crane block during pulling up of the at least one of the sheaves or sheave blocks 6 to be decoupled.

Referring to FIGS. 7, 8 and 18, the sheave blocks 6 may be hoisted out of the crane block until the auxiliary ropes are pulled tight. At that moment the auxiliary line may be switched to constant tension mode.

The sheave blocks 6 may then be hoisted towards the support beam 12 with a constant downwards pulling tension from the auxiliary line. This is advantageous because the sheave blocks 6 are very light in weight. When the sheave blocks 6 can be reconnected to the crane block 3 after an ocean transit, the same auxiliary line 8 may be used to pull the sheave blocks 6 down to the crane block 3 again. The auxiliary ropes 8 therefore may stay connected to the sheave blocks 6 during ocean transit.

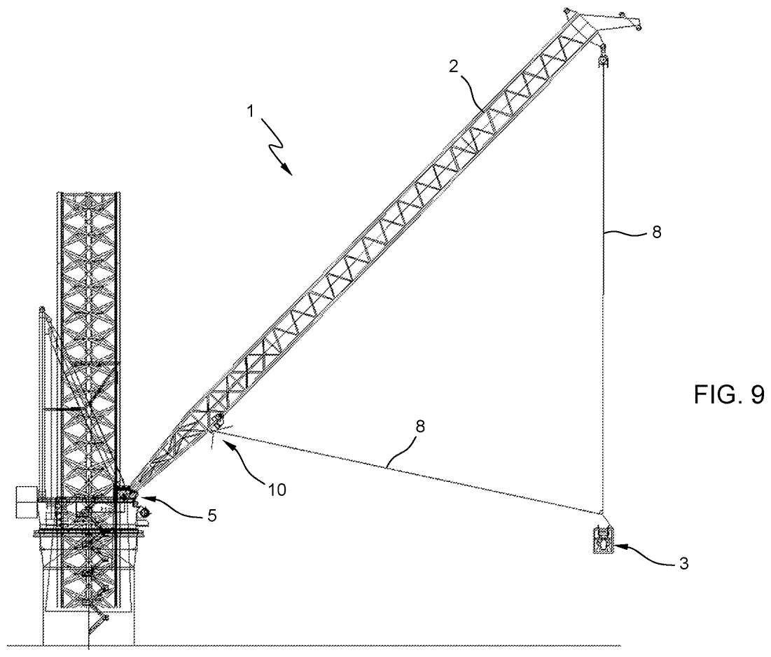

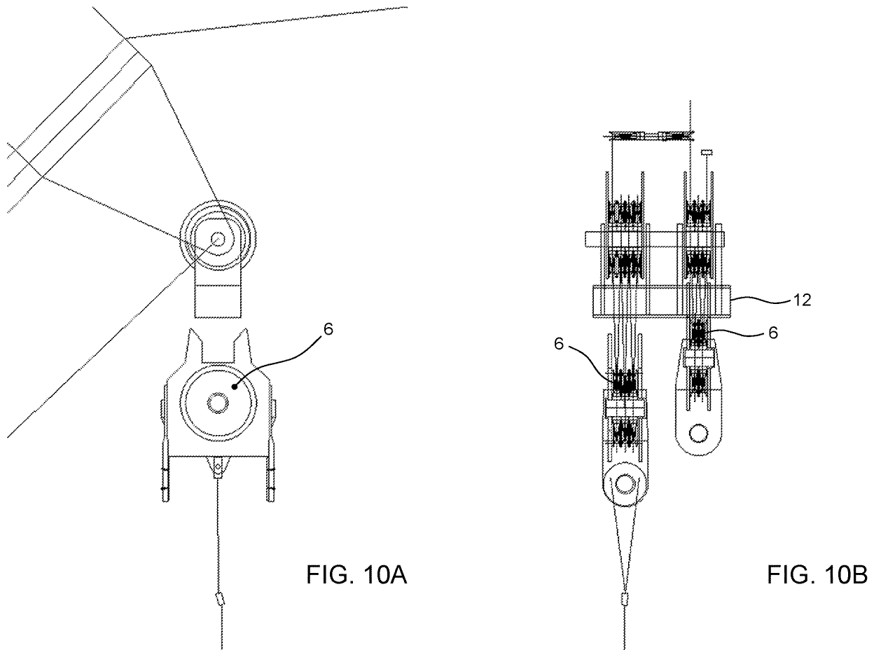

FIG. 9 shows a schematic side view of the crane 1 comprising the crane block 3, wherein the at least one of the sheaves or sheave blocks 6 to be decoupled have been pulled up towards the crane boom 2. FIGS. 10a and 10b show corresponding schematic side views of the at least one of the sheaves or sheave blocks 6 to be decoupled after being pulled up towards the crane boom.

From FIG. 10b, it can be seen that the sheaves or sheave blocks 6 may have become misaligned during pulling up as the sheaves or sheave blocks might rotate. When this happens, the sheave blocks 6 may not fit well into a receiving opening of the support beam 12 anymore. In order to overcome this issue, a pull on the main hoist line 4 may be increased. In case the sheaves or sheave blocks 6 comprise a connecting element 9, this will ensure the sheaves or sheave blocks 6 to stay connected to the connecting element 9. The connecting element 9 may comprise a spreader bar in order to prevent the sheaves and sheave lines to tangle during pulling up.

Referring to FIGS. 9 and 10, the sheave blocks 6 may be pulled up until there is (controlled) contact between the sheave block 6 and the support beam 12 at the crane boom end.

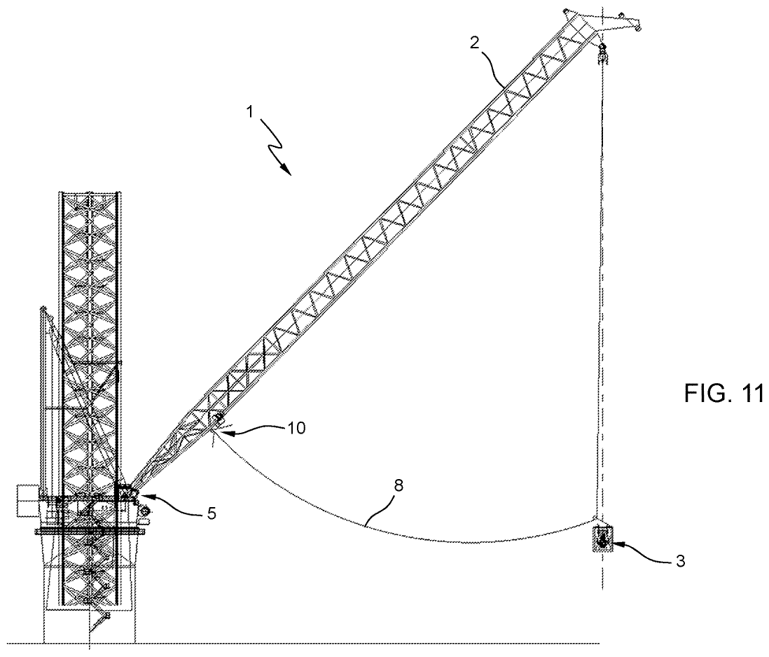

FIG. 11 shows a schematic side view of the crane 1 comprising the crane block 3, wherein a main hoist line is tightened after the at least one of the sheaves or sheave blocks to be decoupled have been pulled up towards the crane boom. As such the tension on the tugger line can be somewhat released without allowing the tugger line to fall slack.

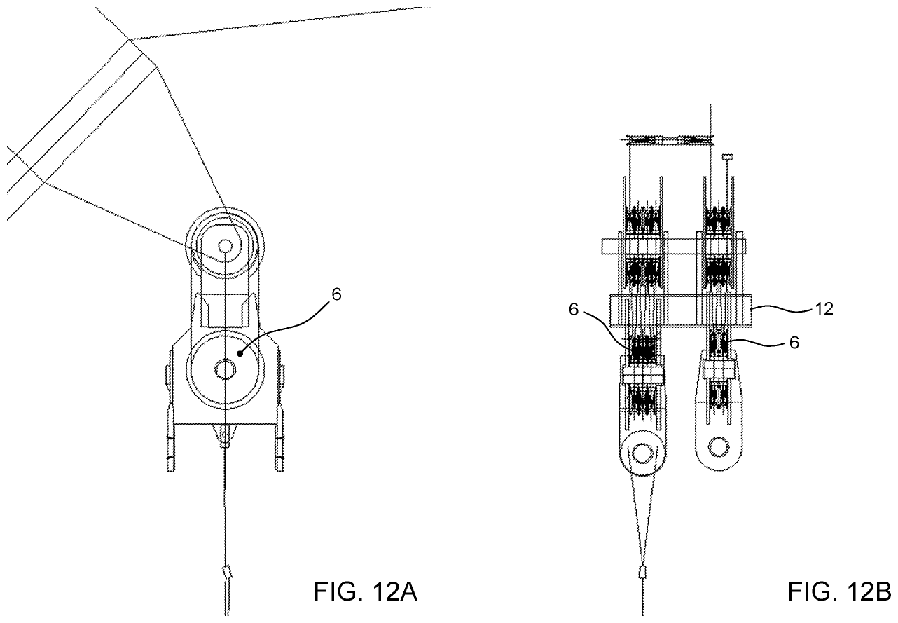

FIGS. 12a and 12b show schematic side views of the at least one of the sheaves or sheave blocks 6 to be decoupled after tightening of the main hoist line 4. The sheaves or sheave blocks 6 are now aligned and pulled towards the crane boom 2 in order to prevent releasing or coming off of the sheaves or sheave blocks 6.

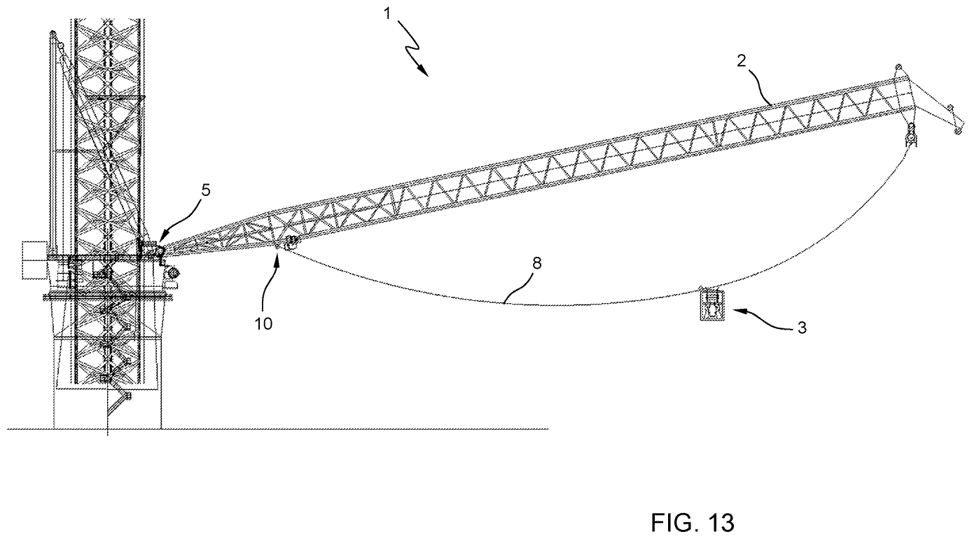

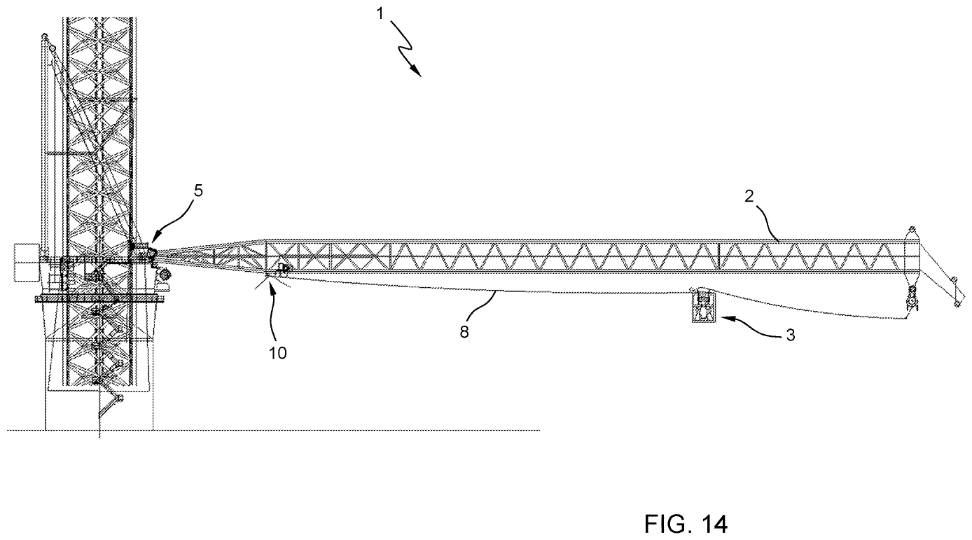

The method may further comprise, lowering the crane boom towards the vessel into a rest position. This is illustrated in FIG. 13, showing a schematic side view of the crane 1 comprising the crane block 3, wherein the crane boom 2 is being lowered into a rest position, and in FIG. 14, showing a schematic side view of the crane 1 comprising the crane block 3, wherein the crane boom 2 has been brought to the rest position. In FIG. 14, the rest position is shown as a substantially horizontal position of the crane boom 2, however, it is also envisaged that the crane boom 2 may be resting in a position wherein the angle of inclination a is significantly larger than 0 degrees.

The crane block 3 may be lowered into a cradle mounted on the vessel. In case of multiple crane blocks 3, a cradle per part of each of the multiple crane blocks may be provided, or one or more cradles may be provided which can comprise two or more parts of the crane block.

During pulling of the to the auxiliary line connected sheaves or sheave blocks 6 towards the crane boom 2, the auxiliary line 8 may advantageously be tensioned, for example in a constant tension mode. This pre-tensioning determines a hauling part tension on the sheaves.

During lowering the crane boom into the rest position, the to the auxiliary line connected line may advantageously be tensioned, for example in a constant tension mode, in order to provide more stability and controllability of the operation, resulting in an increased safety.

The invention further provides the vessel comprising the crane 1, the crane 1 comprising the crane boom 2 with at least one crane block 3, the at least one crane block 3 comprising at least one sheave block 6 comprising at least one sheave of which at least one sheave block 6 is decouplable from a part of the at least one crane block 3, wherein the crane boom 2 is longer than a length of the vessel, the vessel being provided with a boom rest to receive the crane boom 2 in a rest position, e.g. for sailing, wherein the vessel further is provided with a cradle for receiving the part of the at least one crane block 3 and decoupling the part of the at least one crane block 3 from the at least one decouplable sheave or sheave block 6 when the part of the at least one crane block 3 is in the cradle and the crane boom 2 is in an inclined position a.

The boom rest may be arranged along a similar angle as the inclination angle in the resting position, for example about 0 degrees, or significantly more than 0 degrees. The boom rest may comprise a shape corresponding to the shape of the crane boom 2. The boom rest may comprise additional fastening elements to safely fixate and/or fasten the crane boom 2 to the boom rest.

The vessel may be provided with a boom rest extension, extending outside of the vessel, the boom rest extension being provided with the boom rest for receiving the crane boom 2 in rest position. The boom rest extension may provide shielding of the crane boom 2 from external factors such as wind and water. The boom rest extension may form an elongation of the boom rest and may comprise a similar shape and/or structure as the boom rest, or may comprise other or additional materials and/or components at an outer edge to provide a better protection of the crane boom 2.

The cradle may be provided on the boom rest extension, preferably adjacent the boom rest. Alternatively, the cradle may be provided on the vessel.

Referring to FIG. 14, the crane boom 2 may be lowered in boom rest while the auxiliary line stays connected to sheave blocks 6 when stored against the support beam 12. The part of the crane block 3 may be stored in the cradle on the boom rest structure. The auxiliary line may stay connected because for the reverse operation when the sheave blocks 6 are to be connected to the part of the crane block 3 again, the sheave blocks 6 may be pulled down from their position at the support beam 12 towards the part of the crane block 3 again. The own weight of the sheave blocks 6 may be insufficient to lower by themselves.

Concerning FIG. 15, a possible location for the cradle is schematically shown, just behind a boom support interface structure.

FIG. 16a shows the crane block 3 when the sheaves or sheave blocks 6 are coupled to the part of the crane block. FIG. 16b shows the crane block 3 when the sheaves or sheave blocks 6 are decoupled to the part of the crane block.

FIG. 17 shows a side view of part of a crane comprising a boom rest extension. The side view shows the auxiliary line routing from boom 2 to the boom rest. An elevation may be approximately about 31 m above a deck of the vessel.

FIG. 18 shows a top view of a vessel comprising a crane, wherein the auxiliary line is routed from the boom 2 to the boom rest.

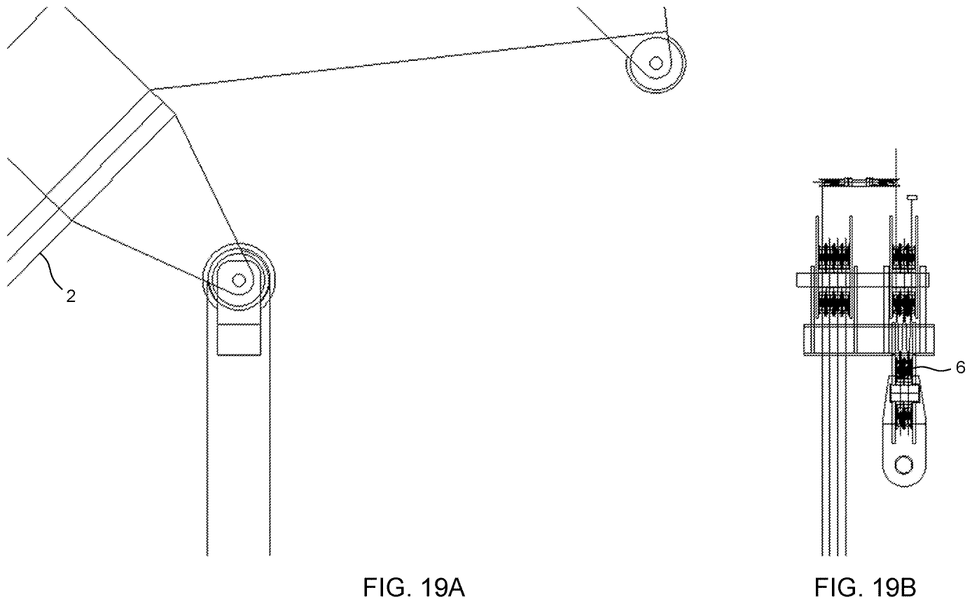

FIGS. 19A and 19B show side views of a top of the crane boom in the case that not all the sheaves or sheave blocks have been pulled up.

For the purpose of clarity and a concise description, features are described herein as part of the same or separate embodiments, however, it will be appreciated that the scope of the claims and disclosure may include embodiments having combinations of all or some of the features described. It may be understood that the embodiments shown have the same or similar components, apart from where they are described as being different.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage. Many variants will be apparent to the person skilled in the art as long as they are comprised within the scope of the invention defined in the following claims.

1. A method for decoupling a part of a crane block comprising at least one sheave block comprising at least one sheave from a crane boom of a crane mounted onto a vessel, the method comprising:
positioning the crane boom in an inclined position;
lowering the part of the crane block towards the vessel;
connecting an auxiliary line to at least one of the at least one sheave block to be decoupled from the part of the crane block;
decoupling the to the auxiliary line connected sheave blocks from the part of the crane block;
pulling the to the auxiliary line connected sheave blocks towards the crane boom.

2. The method according to claim 1, further comprising, lowering the crane boom towards the vessel into a rest position.

3. The method according to claim 1, wherein the part of the crane block is lowered into a cradle mounted on the vessel.

4. The method according to claim 1, wherein during pulling the to the auxiliary line connected sheave blocks towards the crane boom, the auxiliary line is being tensioned.

5. The method according to claim 2, wherein during lowering the crane boom into the rest position, the auxiliary line is being tensioned.

6. The method according to claim 1, wherein, when two or more sheave blocks are being decoupled from the crane block, a connection element is provided between hoisting lines of the sheave blocks.

7. A vessel comprising a crane, the crane comprising a crane boom with at least one crane block, the at least one crane block comprising at least one sheave block comprising at least one sheave of which at least one sheave block is decouplable from a part of the at least one crane block, wherein the crane boom is longer than a length of the vessel, the vessel being provided with a boom rest to receive the crane boom in a rest position, wherein the vessel further is provided with a cradle for receiving the part of the at least one crane block and decoupling the part of the at least one crane block from the at least one decouplable sheave block when the part of the at least one crane block is in the cradle and the crane boom is in an inclined position.

8. The vessel according to claim 7, the vessel being provided with a boom rest extension, extending outside of the vessel, the boom rest extension being provided with the boom rest for receiving the crane boom in rest position.

9. The vessel according to claim 8, wherein the cradle is provided on the boom rest extension.

10. The vessel according to claim 7, wherein the crane is provided with a support structure, wherein the support structure is arranged near a crane boom end, for abutment with the decoupled sheave blocks when pulled up.

11. The vessel according to claim 10, wherein the support structure is provided with seats to receive the decoupled sheave blocks.

12. The vessel of claim 7, wherein the rest position of the crane boom is for sailing.

13. The vessel of claim 9, wherein the cradle is provided on the boom rest extension, adjacent the boom rest.
